(19) United States
(12) Patent Application Publication
(10) Pub. No.: US 2022/0067589 A1
(43) Pub. Date: Mar. 3, 2022

(54) METHOD AND SYSTEM FOR TESTING MACHINE LEARNING MODELS

(71) Applicant: Arm Cloud Technology, Inc., San Jose, CA (US)

(72) Inventors: Bernard BURG, Menlo Park, CA (US); Saina LAJEVARDI, San Jose, CA (US); Michael LUBINSKY, San Jose, CA (US); Yue ZHAO, San Jose, CA (US)

(21) Appl. No.: 17/005,007

(22) Filed: Aug. 27, 2020

(51) Int. Cl. G06N 20/20; G06F 8/65

(52) U.S. Cl. CPC G06N 20/20; G06F 8/65

(57) ABSTRACT

A method performed by an electronic device for testing machine learning models is described. The electronic device includes a program for executing a first machine learning model and a second machine learning model. The electronic device receives a machine learning model update data package and generates the second machine learning model from the update data package by partially or fully updating the first machine learning model. When the program is executed, both the first and second machine learning model use a common set of input data to perform inference. The program collects outputs from the first machine learning model and the second machine learning model, for further analysis.

### BACKGROUND OF THE INVENTION

### Field of the Invention

The present invention relates to a method and system for testing machine learning models.

### Description of the Related Technology

An embedded system is a combination of a processor, a memory and other hardware that is designed for a specific function or which operates within a larger system. Examples of embedded systems include, without limitation, microcontrollers, ready-made computer boards, and application-specific integrated circuits. Embedded systems may be found within many Internet of Things (IoT) devices. Some embedded systems may utilize a machine learning model to analyze and process data collected from various sensors provided in the embedded system. Using machine learning models in this way allows for more efficient and effective processing of the large volume of data collected by the IoT device

A drawback, however, is that these machine learning models may lose accuracy over time, due to new input behavior (such as the evolution of input data), degradation or loss of accuracy of input sensors, or upgrading of the input sensors. Consequently, machine learning models deployed on IoT embedded systems require updates, sometimes as frequently as on an hourly basis.

### SUMMARY

According to a first aspect there is provided a method performed by an electronic device for testing machine learning models, the electronic device comprising a program for executing a first machine learning model and a second machine learning model, the method comprising: the electronic device receiving a machine learning model update data package; partially or fully updating a first machine learning model to generate a second machine learning model using the machine learning model update data package; executing the program, whereby the program executes both the first machine learning model and the second machine learning model using a common set of input data; collecting outputs from the first machine learning model and the second machine learning model for analysis.

According to a second aspect there is provided an electronic device with a processing element and a data storage element, the storage element containing code that, when executed by the processing element, causes the electronic device to perform a method for testing machine learning models, the method comprising: the electronic device receiving a machine learning model update data package; partially or fully updating a first machine learning model to generate a second machine learning model using the machine learning model update data package; executing the program, whereby the program executes both the first machine learning model and the second machine learning model using a common set of input data; collecting outputs from the first machine learning model and the second machine learning model for analysis.

According to a third aspect there is provided a non-transitory computer-readable storage medium containing code that, when executed by an electronic device, causes the electronic device to perform a method for testing machine learning models, the method comprising: the electronic device receiving a machine learning model update data package; partially or fully updating a first machine learning model to generate a second machine learning model using the machine learning model update data package; executing the program, whereby the program executes both the first machine learning model and the second machine learning model using a common set of input data; collecting outputs from the first machine learning model and the second machine learning model for analysis.

### BRIEF DESCRIPTION OF THE DRAWINGS

FIG. 1 is a schematic diagram showing hardware of an embedded system;

FIG. 2 is a schematic diagram showing a software stack;

FIG. 3 is a schematic diagram showing the structure of an application;

FIG. 4 is a schematic diagram showing installation of an updated machine learning model;

FIGS. 5a and 5b are a flow chart showing steps for the generation and installation of a machine learning model on an embedded system;

FIG. 6 is a schematic diagram showing an application for AB testing after an update;

FIG. 7 is a flow chart showing a method of selecting a model in A/B testing in a case that the machine learning models are configured for unsupervised learning;

FIG. 8 is a flow chart illustrating implementation of an A/B testing model in a case that the machine learning models are configured for supervised learning;

### DETAILED DESCRIPTION OF CERTAIN INVENTIVE EMBODIMENTS

Before discussing the embodiments with reference to the accompanying figures, the following description of embodiments is provided.

A first embodiment provides a method performed by an electronic device for testing machine learning models, the electronic device comprising a program for executing a first machine learning model and a second machine learning model, the method comprising: the electronic device receiving a machine learning model update data package; partially or fully updating a first machine learning model to generate a second machine learning model using the machine learning model update data package; executing the program, whereby the program executes both the first machine learning model and the second machine learning model using a common set of input data; collecting outputs from the first machine learning model and the second machine learning model for analysis.

The machine learning model update data package may be a delta update of the program on the electronic device. The delta update may include a difference between the first machine learning model and the second machine learning model to allow the second machine learning model to be generated from the update package. In this way, in some embodiments, the amount of data that needs to be transferred to the electronic device can be reduced.

The first machine learning model and the second machine learning model may be different versions of a common machine learning model Accordingly, generating the second machine learning model from the update data package may comprise generating a version of the common machine learning model from an earlier version of the common machine learning model using the update data package.

The machine learning model update may be received via a wireless connection.

The program may execute the first machine learning model and the second machine learning model in parallel. In other implementations, the program may execute the first machine learning model and the second machine learning model sequentially.

In some embodiments, the electronic device may be configured to send the results of executing the first machine learning model and the second machine learning model to a related infrastructure for analysis.

In other embodiments, analysis of the results of executing the first machine learning model and the second machine learning model may be performed on the electronic device.

The electronic device may be configured to perform unsupervised learning. In such embodiments, executing the first machine learning model may generate first output values and executing the second machine learning model may generates second output values. The method may comprise running the program on a plurality of sets of input data to generate a plurality of sets of first and second output values; analyzing the first and second output values to identify a property of each of the first and second output values, and selecting one of the first machine learning model and the second machine learning model based the identified properties. The method may further comprise analyzing the first and second output values to see if the property has deviated beyond a threshold amount from a desired performance of the machine models. The property may be an intra-class entropy and/or an extra-class entropy.

The method may comprise selecting one of the first machine learning model and second machine learning model based on the model having output values that have at least one of a smaller intra-class entropy value and a larger extra-class entropy value.

In other embodiments, the electronic device is configured to perform supervised learning. Executing the first machine learning model may generate first output values and executing the second machine learning model may generate second output values. The method may comprise running the program on a plurality of sets of input data to generate a plurality of sets of first and second output values; calculating a first entropy associated with the first output values and a second entropy associated with the second output values; and selecting one of the first machine learning model and the second machine learning model based on the calculated first entropy and second entropy.

The program may be configured to send a request to receive an updated model if the first entropy and second entropy do not meet a predetermined criteria. The predetermined criteria may based on a deviation of the value of the first entropy and/or second entropy from a threshold value associated with the machine learning models.

The method may comprise selecting one of the first machine learning model and second machine learning model based on the values of the first entropy and second entropy. The method may comprise selecting the first machine learning model in a case that the first entropy is lower than the second entropy and selecting the second machine learning model in a case that the second entropy is lower than the first entropy.

The method may further comprise checking the model update package for a signature to prevent installation of malicious code on the electronic device.

A second embodiment provides electronic device comprising a processing element and a data storage element, the storage element storing code that, when executed by the processing element, causes the electronic device to perform a method for testing machine learning models, the method comprising: the electronic device receiving a machine learning model update data package; partially or fully updating a first machine learning model to generate a second machine learning model using the machine learning model update data package; executing the program, whereby the program executes both the first machine learning model and the second machine learning model using a common set of input data; collecting outputs from the first machine learning model and the second machine learning model for analysis.

The electronic device may further comprise a wireless connection element.

The data storage element may further store code that, when executed by the processing element, provides a secure transfer function that checks a signature included with data transfers to prevent the installation of malicious code.

The electronic device may be an embedded system.

A further embodiment provides a non-transitory computer-readable storage medium containing code that, when executed by an electronic device, causes the electronic device to perform a method for testing machine learning models, the method comprising: the electronic device receiving a machine learning model update data package; partially or fully updating a first machine learning model to generate a second machine learning model using the machine learning model update data package; executing the program, whereby the program executes both the first machine learning model and the second machine learning model using a common set of input data; collecting outputs from the first machine learning model and the second machine learning model for analysis.

A further embodiment provides a method performed by an infrastructure element for sending a machine learning model update package to an electronic device, the method comprising: identifying a machine learning model currently installed on the electronic device; creating a delta update corresponding to a difference between a machine learning model to be installed on the electronic device and the identified machine learning model currently installed on the electronic device; and sending a machine learning model update package to the electronic device including the delta update.

The machine learning model update package may further include statistics relating to performance of the machine learning model to be installed. The statistics may include a measure of entropy of the outputs of the machine learning model to be installed. The measure of entropy may be one of an intra-class entropy and an extra-class entropy.

Particular embodiments will now be described with reference to the Figures.

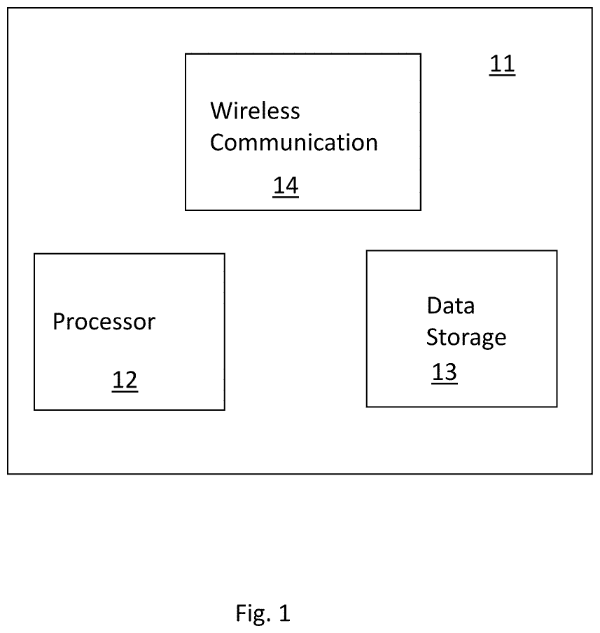

FIG. 1 is a schematic diagram showing hardware of an embedded system in the form of a board 11. The board 11 may, for example, be an Arduino® board or NXP® microcontroller. It will be appreciated that such a board 11 may include further components that are not shown nor described. The board 11 includes a processor 12, and a data storage unit 13. A wireless communication module 14 is also provided to enable wireless communication. The wireless communication module 14 enables communication over Wi-Fi® and/or Bluetooth®. In other implementations, the wireless communication module 14 may allow communication over a mobile telecommunications network. The wireless communication module 14 is configured to allow transmission of data to and from the board 11.

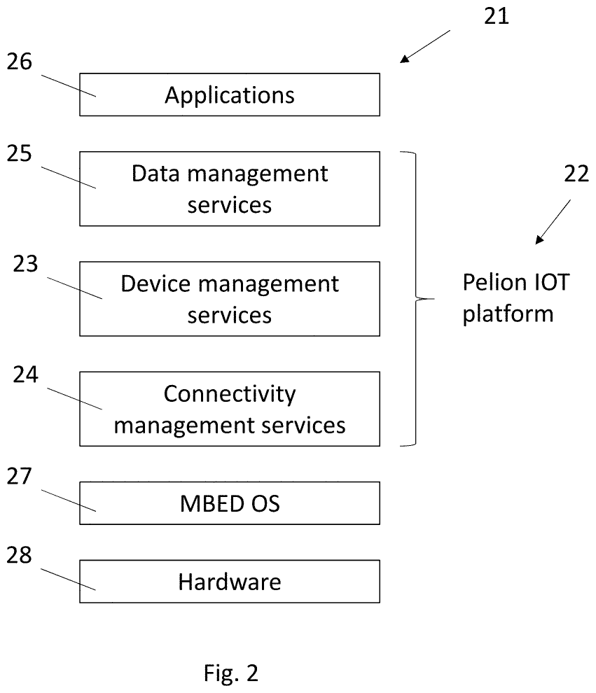

FIG. 2 is a schematic diagram showing a software stack 21 stored on the board 11. In this embodiment, the Pelion IoT platform 22 is installed on the board 11. It will be appreciated that other software stacks and IoT platforms could be implemented in other embodiments. The Pelion IoT platform 22 includes device management services 23 to facilitate the deployment and management of the board 11. The device management services 23 enable remote access to the board 11 including over-the-air updates, installation of software patches and extraction of data from the board 11. Additionally, device management services 23 includes a security feature that signs every data transmission and checks a signature on incoming data. The device management services 23 prevent installation of malicious code on the board 11 by preventing installation of code that does not have a valid signature recognized by the device management services 23. The device management services 23 interoperate with connectivity management services 24, which enables maintenance of secure and reliable connection between the board 11 and related infrastructure. The connectivity management service control wireless connection of the board 11 using the wireless communication module 13 mentioned earlier. The Pelion IoT platform 22 also includes data management services 25, which provides data management and analytics functions to allow the board 11 to ingest, store, and analyse data.

The software stack of FIG. 2 further includes applications 26, which may be installed on the board 11. The applications 26 may make use of libraries stored on the board (not shown), including TinyML® libraries which support the running of machine learning models on the board 11. The example of TinyML® is used here to support the running of small versions of machine learning models that can be run on embedded systems. However, it will be appreciated that other software solutions may be used in place of TinyML®. The software stack is run on the MBED Operating System 27. FIG. 2 also shows hardware 28 which includes the previously described processor 12, data storage 13, and wireless communication module 14, as well as further components such as sensors that may be provided on the board 11.

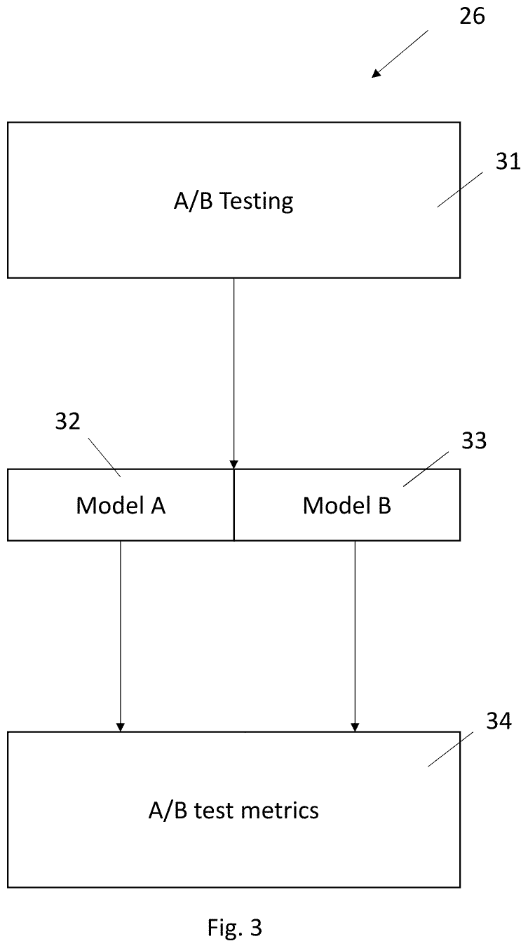

FIG. 3 is a schematic diagram showing the structure of an application 26 provided on the board 11 for performing A/B testing. The application includes a code portion 31 for performing A/B testing, a machine learning model A 32 and a machine learning model B 33. The code portion 31 controls the application including receipt of input data and causing the input data to be processed by the two machine learning models. When the application 26 is run, a set of input data is processed by each of model A 32 and model B 33. Each of model A 32 and model B 33 generates output values in the form of node activations and, in the embodiment shown in FIG. 3, the node activations are compiled into A/B test metrics 34.

A/B testing as performed by the application 26 is a method of testing two different machine learning models, in this case machine learning model A 32 and machine learning model B 33, using the same input data. By collecting statistics on the performance of the two machines learning models, the performance of the machine learning models can be evaluated against each other. This allows the better performing machine learning model to be selected for use in further inference processing.

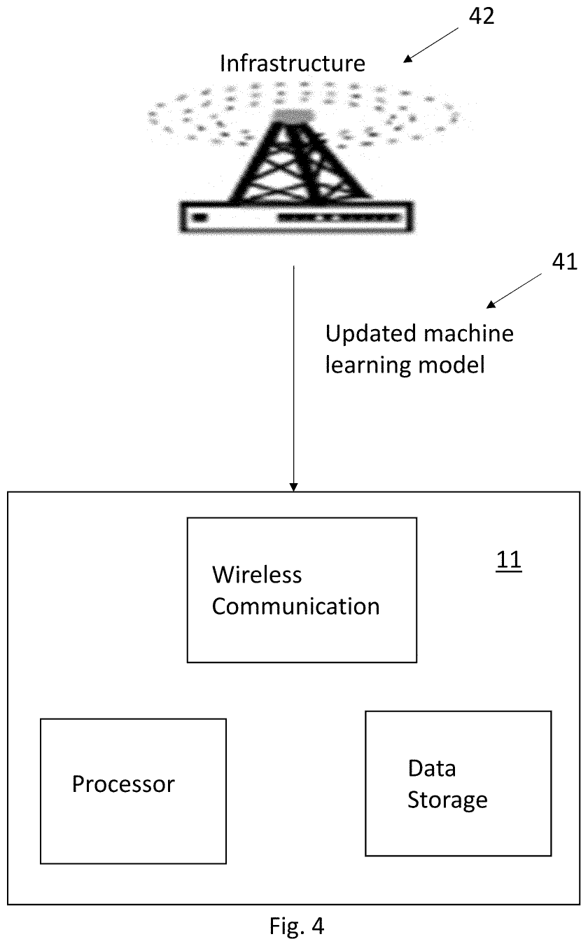

FIG. 4 is a schematic diagram showing installation of an updated machine learning model 41 on board 11. The updated machine learning model is developed in a related infrastructure 42 and is transmitted wirelessly to the board 11. In some embodiments the related infrastructure may include software for development of the application 26, such as a TinyML® development platform, which is well suited for deep learning. Alternatively, classic statistical machine learning techniques such as linear regression, support vector machine (SVM), and Naïve Bayes algorithms are supported by embedded libraries and may be used in place of TinyML. The related infrastructure 42 could receive the updated machine learning model after it has been developed elsewhere. The related infrastructure 42 is in wireless communication with the board 11 and may be a central server, a data center, a cloud environment, a computer, a mobile device, or any other suitable computing environment for the storage and transmission of data. The wireless connection between the related infrastructure 42 and the board 11 is controlled, on the board 11, by the connectivity management services 24. A service to ensure security of data transmissions between the related infrastructure 42 and the board 11 is provided, on the board, by the Device Management Services 23. Related services to control the wireless connection and security of data transmission are provided at the related infrastructure 42.

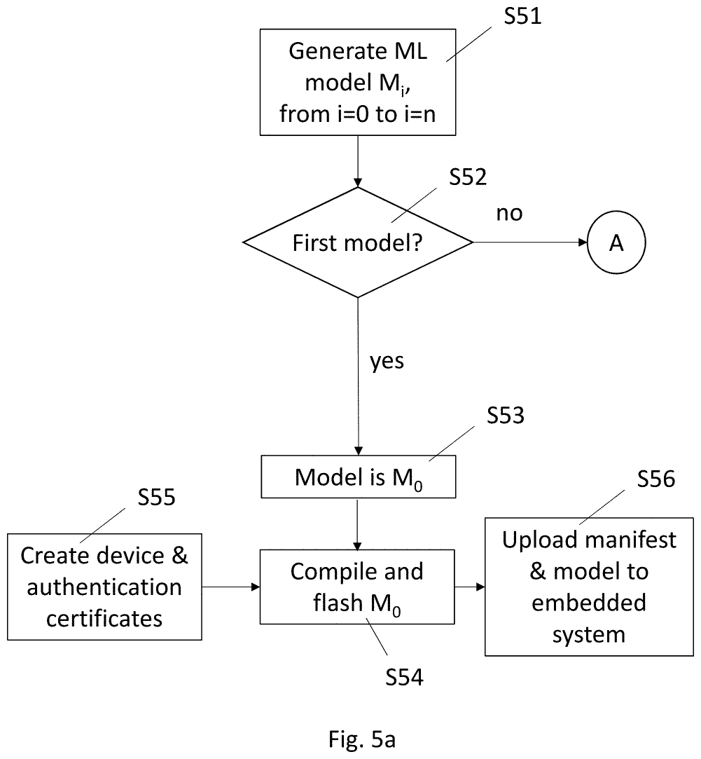

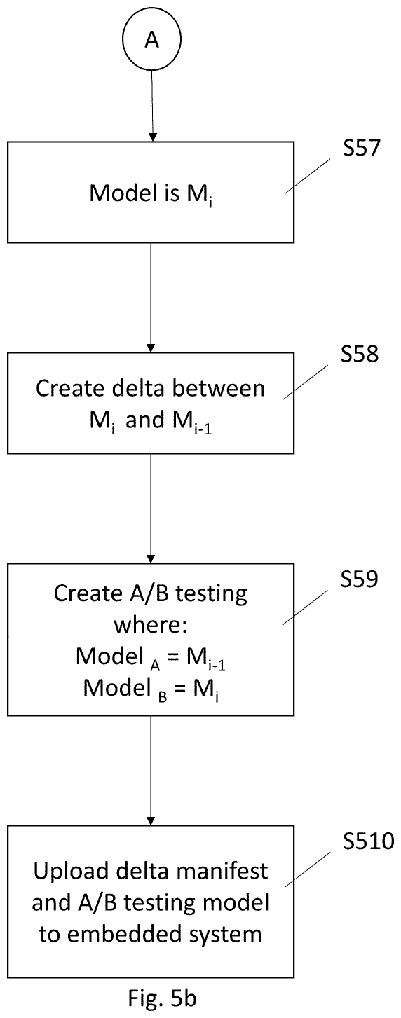

FIGS. 5a and 5b are a flow chart showing steps of a method for the generation and transmission of an updated machine learning model to the board 11. In step S51, a machine learning model Mi is developed in the related infrastructure 42. This step may involve, in some circumstances, training a new machine learning model based on a set of training data. In other circumstances, an existing training model may be refined by further training using additional training data. This model is then downsized to solely use operations supported by the board 11 and its embedded libraries and to fit into the available memory along with the data sampled on the board 11. Downsizing operations encompass quantization, and, for deep learning algorithms, graph shrinking, operator dropout and inline pruning. In step S52, a determination is made as to whether a new model (a first version model) is being sent to the board 11 or whether an update to an existing model is being sent. The method branches at step S52. If a model to be sent to the board 11 is a first version machine learning model, the process proceeds to step S53. In step S53, the model is denoted M₀. and, in step S54, the entire model M₀ is compiled and flashed along with some device and authentication certificates. In step S55, the device and authentication certificates are generated for security so that the board 11 will be able to perform security checks on the data containing the received model. Upon device certificates and authentication certificates being created in step S55, and the machine learning model being compiled and flashed in step S54, the compiled machine learning model M₀ is uploaded S56 to the board 11 as an update package.

If, however, the machine learning model is not a first version machine learning model, at step S52 the process is instead directed to S57, as shown in FIG. 5b. In step S57, the machine learning model is denoted Mi, where i is a version number for the model that increases incrementally with each version of the machine learning model. The version number i is selected depending on how many versions of the model have been previously developed and the version currently installed on the board 11. The related infrastructure 42 then, in step S58, calculates a binary difference between the data in the machine learning model Mi to be sent to the board 11 and a preceding version of the same machine learning model, Mi-1, which is already installed on the board 11. This binary difference between the two models is referred to as the model delta. The model delta is generated using a tool, bsdiff. Bsdiff is a tool for building and applying patches to binary files. Other means of generating binary deltas between machine learning models are known in the art, and one of these could be employed in other embodiments.

Once the model delta is generated, in step S59 the code portion for A/B testing code 59 is updated to perform A/B testing with the two machine learning models Mᵢ₋₁ and Mᵢ. Within the A/B testing, machine learning model Mᵢ₋₁ forms model A, and machine learning model Mᵢ forms model B.

In step S510, both the updated code for A/B testing created in S59 and the model delta generated in step S58 are uploaded to the board 11 as an update package. The use of binary delta in the update package is useful when updating ML models in IoT devices in the field because in some applications, network bandwidth is limited and costly. In other applications, power available to the IoT device may be limited, for example in the case of a coin cell operated board, so saving power by making less use of the wireless communication module 14 may be desirable.

Upon receiving an update package over the wireless connection, the board 11 updates the application 26 so that the A/B testing code 31 portion is updated, and the machine learning models are updated in accordance with the configuration in the update package.

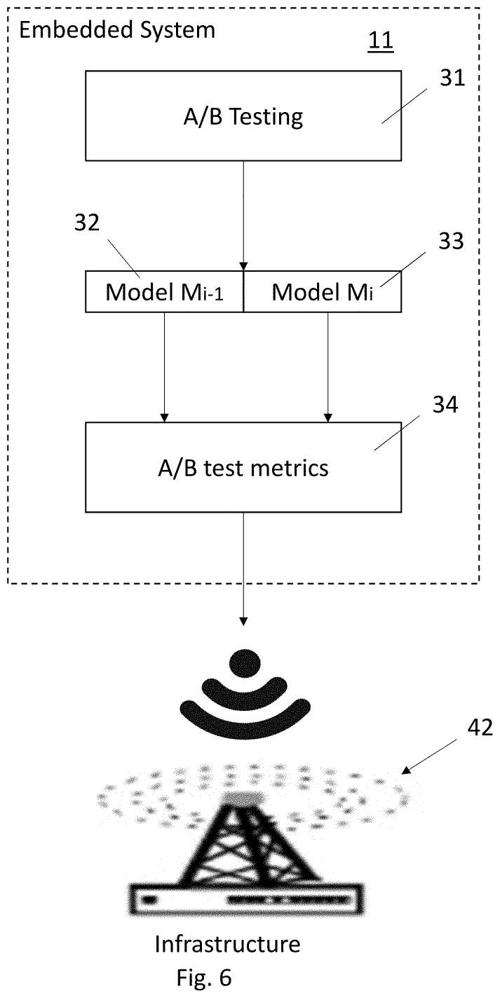

FIG. 6 is a schematic diagram showing the application for A/B testing after the update. The A/B testing code 31, when run, causes input data to be processed by machine learning model Mᵢ₋₁ and machine learning model Mᵢ. The two machine learning models 32 and 33 may be executed sequentially, or in parallel by the board 11. The results, in the form of node activations, from running both model A 32 and model B 33 are then compiled into test metrics 34, which provide a measure for the performance of both models. These test metrics 34 may be a set of performance metrics, a set of features, mathematical expressions, measures of entropy, or any other suitable metrics. The test metrics could be an accuracy measurement e.g. 82% accuracy, a measure of false positives and/or a measure of false negatives.

The A/B test metrics are then sent to the related infrastructure 42 to allow determination of which of the two machine learning models performed better on the input data. The sending of test metrics rather than the node activation data from the two models may be useful in reducing the amount of data that needs to be sent to the related infrastructure and thereby reducing power requirements at the board 11.

The A/B testing application shown in FIGS. 3 and 6 require at least two machine learning models to perform a comparison. In other implementations, which will not be described in detail, more than two machine learning models could be stored on the board 11 and used for comparison. When updating the machine learning models being tested, in situations where model A 32 already exists on the board, only the model delta between model A 32 and model B 33 is included in the update package. It will be understood that when the application is first installed on the board 11 both model A 32 and model B 33 will need to be provided to the board 11.

Once the update package has been downloaded to the board 11, the board 11 generates machine learning model Mᵢ from the update using existing model on the board Mᵢ₋₁ and the model delta to form of the updated machine learning model Mᵢ from the model already existing on the board. When the A/B testing application is run with input data, the board 11 can be used to determine the more suitable model.

The board 11 is usable both in the case where the machine learning models are configured to perform supervised learning and where they are configured to perform unsupervised learning. Each of these examples will now be described.

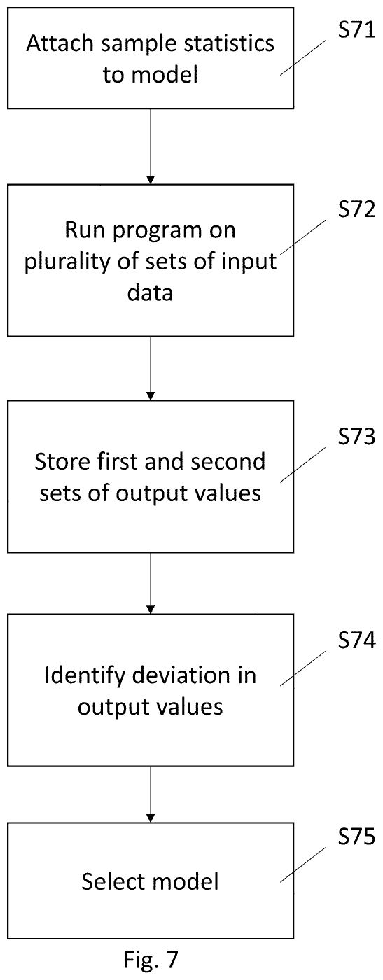

FIG. 7 is a flow chart showing a method of selecting a model in A/B testing when the machine learning models are configured for unsupervised learning. The unsupervised learning model may be a clustering or k-means clustering model. These machine learning models group data items into clusters and evaluate which cluster an input data item belongs to.

At the stage of developing the machine learning model, in step S71, a set of sample data statistics e.g. vector or a buffer of entropies, are attached to the model as part of the update package. In the case of a clustering model, these entropies indicate a degree of variation within a cluster (intra-class entropy) and a degree of separation between the clusters (extra-class entropy). More generally, the sample data statistics attached to the model are statistics that indicate typical dispersion of the activation values for nodes as the model learns from the incoming input data. In particular, the sample data statistics are a measure of the entropy of the set of node values. Each node in the output layer is said to identify a class of outputs (e.g. letters in a character recognition model). The entropy values may be intra-class entropy values and/or extra-class entropy values. The intra-class entropy values indicate how much a node values for a class or cluster vary (for example how much values vary when detecting the letter ‘c’). Extra-class entropy values indicate how different the values are between node activation values. For example, indicating a typical difference between the node values when detecting the letter ‘c’ and when detecting the letter ‘z’.

The sample data statistics are received by the board 11 along with the A/B testing code 31 and the updated machine learning model 33. In step S72, the board 11 runs the A/B testing model. The board 11 runs both machine learning model A 32 and machine learning model B 33 for a plurality of sets of input data, each set of input data being processed by both machine learning models. In step S73, the node activation values from running the machine learning models on the plurality of sets of input data is stored in the data storage 13.

In step S74, the stored node activation values are processed. For each input data set, two sets of node activation values are stored corresponding to model A 32 and model B 33 respectively. For each set of input data, the entropy between node activation data values is calculated to calculate an extra-class entropy. The extra-class entropy may be averaged across the plurality of sets of output data.

An entropy in the activation values for a particular node, across several sets of input data classified in the same cluster, is calculated to generate an intra-class entropy value.

The intra-class and extra-class entropies compared with threshold values to see if the supervised learning models A and B are deviating from desired performance. This may happen if the intra-class entropy values are starting to get large (a cluster within the clustering model is starting to get large) or if the extra-class entropy values start getting small (the clusters are starting to get close to each other and the model is making less clear predictions).

In step S75, the performance of the models over the input data sets are evaluated. This evaluation may include evaluating the intra-class entropy of the node activation values for each model and the extra-class entropy values of the node activation values for each model. A smaller intra-class entropy value and a larger extra-class entropy value is desirable. A small intra-class entropy indicates that the node activation values are quite consistent when a label is to be assigned. For example, the signal may be consistently quite high when a letter ‘c’ is detected in an image. A large extra-class entropy indicates that there is a significant difference between the activation node values in a case where a label is to be assigned. This is desirable because it means that there is a clear signal, such as the node for the letter ‘c’ being much higher than a node activation value for the letter ‘z’ in a case when a ‘c’ is detected.

In step S75, the system will select the machine learning model having output values that have at least one of a smaller intra-class entropy value and a larger extra-class entropy value.

In a case in which neither model A 32 or Model B 33 produce output values that resemble the sample statistics provided with the machine learning model when it was installed across a predetermined number of sets of input data, the system will determine that neither model is working well and request an updated model from the related infrastructure 42.

In other embodiments, the board 11 may use supervised learning to compare the two machine learning models.

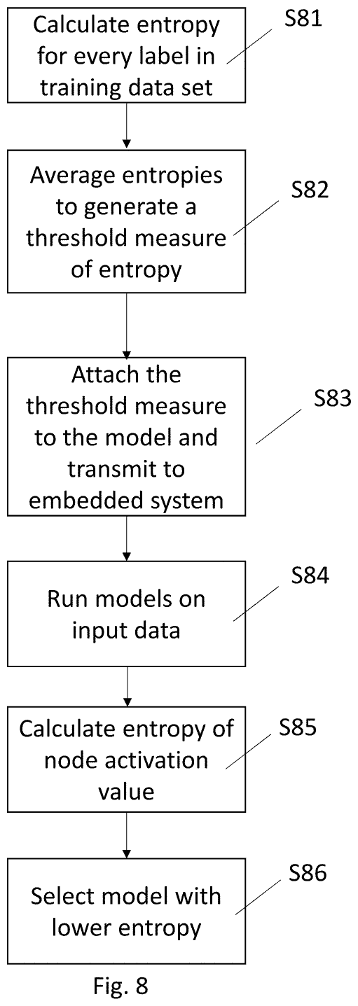

FIG. 8 shows the development and implementation of a supervised learning comparison process.

A supervised machine learning model is developed on the related infrastructure 42 using a set of training data. Each item of training data includes input values, which are input to the neural network, and a label that indicates the correct result. For example, for a machine learning model for recognizing a person in an image, the training data should include the image data and a label that indicates whether or not the image includes a person. The person recognition model may be trained using a set of training images. For each data item (e.g. image) in the set of training data, the trained model will generate a set of node activation values. In the case of a trained neural network, the training data should, in many cases, generate a high node activation corresponding to the label associated with training data. In the example of person recognition, a node should give a high activation value if a person is included in the image of the training data.

In step S81, during development of the machine learning model, an entropy is calculated for activation values in the output layer of the trained model obtained based on the training data set. In a case where the node activation values (probabilities) are relatively close to each other, uncertainty in the model output is high, so entropy is large. In contrast, in a case where the node activation values (probabilities) are relatively far from each other and there is a strong activation value from one output node, uncertainty in the model output is low, so entropy is low. The average of all these entropies is calculated in step S82, providing a threshold measure of entropy. This threshold measure is then attached to the machine learning model and included in the update package sent to the board 11 in step S83. Upon receipt, the application is updated as previously described.

In step S84, the updated application is run on the board 11 for multiple sets of input data. Each set of input data is processed by both machine learning model A 32 and machine learning model B 33. In step S85, entropy values are calculated by the application for the output activation values of each machine learning model. In step S86, the model having the lower entropy in the node activation values is selected for use in subsequent inference.

If none of the models have sufficiently low entropy values for reasonable number of input data items, the application 26 may send a request to the related infrastructure 42 to update the model. This sufficiently low entropy value may be determined as a deviation by a predetermined threshold below the threshold measure of entropy that was sent with the machine learning model. In other implementations, the maximum entropy of certain number of classes could be calculated theoretically (e.g. for two classes). In such implementations, the need for the expected entropy to accompany every model is removed. However, it is anticipated that providing a threshold measure of entropy with the model will be a desirable option, as some data are naturally harder to train on.

In other embodiments where the machine learning models are configured for supervised learning, the models may be evaluated against a predetermined set of input data with a known set of labels. In such a supervised test, the board 11 is provided with a predetermined set of input data and the results of the two models are compared with known correct outcomes. The predetermined set of input data may be input to the board by providing input data to sensors of the board 11. For example, images could be presented to a camera of the board 11 or sounds presented to a microphone of the board 11.

Evaluation of the results of the supervised test may be performed on the board 11 or on the related infrastructure 42. In a case where the results are evaluated on the board, once the supervised test has been performed, the board may send a request to the related infrastructure 42 to receive labels associated with the supervised test. The related infrastructure 42 may send the labels for the supervised test to the board 11 in response to the request. The board may then compare the predictions of the two machine learning models against the received set of labels and evaluate which machine learning model provided more accurate predictions.

In other implementations, after each input data item is processed by machine learning model A 32 and machine learning model B 33, the application may cause the board 11 to send a query to get the label. The related infrastructure sends the label in response to the request from the board 11. The application may suspend processing on the board 11 until the application receives the label. The application resumes processing after receipt of the label and increments a set of scores of the A/B tests. At the end of the predetermined test period, the board 11 will provide a measurement, comparing machine learning model A 32 and machine learning model B 33, to the related infrastructure 42.

In other implementations, the board 11 may perform a supervised test and send the predictions from each of machine learning model A 32 and machine learning model B 33 to the related infrastructure. The infrastructure can then evaluate the predictions of the two machine learning models against the correct set of labels for the test. This implementation may be useful in cases where there is going to be a delay between the board 11 performing the supervised test and the labels against which the machine learning models are going to be evaluated being available. The related infrastructure 42 will typically have more storage and processing power than the board 11 and may be a useful place to store the predictions during the delay. Once the related infrastructure 42 has evaluated the two machine learning models, a result of the evaluation may be sent back to the board 11. This may allow the application 26 to select one of the machine learning models to use for further inference.

Embodiments described above allow A/B testing on a board 11 to select between two machine learning models. It could be considered that such testing between machine learning models may be carried out in simulation away from the board 11. However, it has been found that in some cases the simulations may not adequately reflect how a given machine learning model will perform when implemented on the board 11. This may be due to hardware limitations on the board or other factors. Accordingly, it has been found that providing an application for performing A/B testing is useful because it allows machine learning models, particularly small machine learning models of the type that can be installed on an embedded system, to be tested natively.

In some implementations, a plurality of boards 11 may be connected to a common infrastructure 42. The A/B testing may be performed on one or more boards to test between a model version i and a model version i-1, as previously described. In a case that the infrastructure determines that the model version i performs better than model version i-1 the plurality of boards may be migrated to the model version i. The infrastructure may determine that the model version i performs better either by evaluating the results of the two models directly or by receiving metrics from the board 11 performing A/B testing. The migration of the boards from model version i-1 to model version i may be performed incrementally in batches. For example, if one hundred boards are connected to the infrastructure 42, the boards may be transitioned to the new model in batches of 10-20 percent. This allows the performance of the new model to be evaluated on a larger number of boards before completely transitioning to the new model.

As mentioned in the preceding paragraph, the A/B testing may be performed on several of a plurality of boards 11. This allows a determination of whether or not the new model performs consistently across boards 11. A machine learning mode could be selected that is robust to variations in performance of the boards, perhaps due to variations in the performance of the sensors on the boards or due to differences in location of installation of the boards.

What is claimed is:

1. A method performed by an electronic device for testing machine learning models, the electronic device comprising a program for executing a first machine learning model and a second machine learning model, the method comprising:
the electronic device receiving a machine learning model update data package;
partially or fully updating a first machine learning model to generate a second machine learning model using the machine learning model update data package;
executing the program, whereby the program executes both the first machine learning model and the second machine learning model using a common set of input data; and
collecting outputs from the first machine learning model and the second machine learning model for analysis.

2. A method according to claim 1, wherein the machine learning model update data package is a delta update of the program on the electronic device.

3. A method according to claim 1, wherein the machine learning model update is received via a wireless connection.

4. A method according to claim 1, wherein the electronic device sends the results of executing the first machine learning model and the second machine learning model to a related infrastructure for analysis.

5. A method according to claim 1, wherein analysis of the results of executing the first machine learning model and the second machine learning model is performed on the electronic device.

6. A method according to claim 5, wherein the electronic device is configured to perform unsupervised learning, executing the first machine learning model generates first output values and executing the second machine learning model generates second output values, wherein the method further comprises:
running the program on a plurality of sets of input data to generate a plurality of sets of first and second output values;
analyzing the first and second output values to identify a property of each of the first and second output values, and selecting one of the first machine learning model and the second machine learning model based on the identified properties.

7. A method according to claim 6, wherein the property is one of an intra-class entropy and an extra-class entropy and the step of selecting a one of the first machine learning model and second machine learning model comprises selecting the model having output values that have at least one of a smaller intra-class entropy value and a larger extra-class entropy value.

8. A method according to claim 5, wherein the electronic device is configured to perform supervised learning, executing the first machine learning model generates first output values and executing the second machine learning model generates second output values, the method comprising:
running the program on a plurality of sets of input data to generate a plurality of sets of first and second output values;
calculating a first entropy associated with the first output values and a second entropy associated with the second output values; and
selecting one of the first machine learning model and the second machine learning model based on the calculated first entropy and second entropy.

9. A method according to claim 8, wherein the program is configured to send a request to receive an updated model if the first and second entropy do not meet a predetermined criteria.

10. A method according to claim 8, comprising selecting the first machine learning model in a case that the first entropy is lower than the second entropy and selecting the second machine learning model in a case that the second entropy is lower than the first entropy.

11. A method according to claim 1 further comprising checking the machine learning model update package for a signature to prevent installation of malicious code.

12. An electronic device comprising a processing element and a data storage element, the storage element storing code that, when executed by the processing element, causes the electronic device to perform a method for testing machine learning models, the method comprising:
the electronic device receiving a machine learning model update data package;
partially or fully updating a first machine learning model to generate a second machine learning model using the machine learning model update data package;
executing the program, whereby the program executes both the first machine learning model and the second machine learning model using a common set of input data; and
collecting outputs from the first machine learning model and the second machine learning model for analysis.

13. An electronic device according to claim 12, further comprising a wireless connection element.

14. An electronic device according to claim 13, wherein the data storage element further stores code that, when executed by the processing element, provides a secure transfer function that checks a signature included with data transfers to prevent the installation of malicious code on the embedded electronic device.

15. An electronic device according to claim 12, wherein the electronic device is an embedded system.

16. A non-transitory computer-readable storage medium containing code that, when executed by an electronic device, causes the electronic device to perform a method for testing machine learning models, the method comprising:
the electronic device receiving a machine learning model update data package;
partially or fully updating a first machine learning model to generate a second machine learning model using the machine learning model update data package;
executing the program, whereby the program executes both the first machine learning model and the second machine learning model using a common set of input data;
collecting outputs from the first machine learning model and the second machine learning model for analysis.
